(19) United States
(12) Patent Application Publication
(10) Pub. No.: US 2004/0026997 A1
(43) Pub. Date: Feb. 12, 2004

(54) Fail-safe mode releasing method of a vehicular multi-function switch

(76) Inventor: Chung-Tae Kim, Gyeonggi-do (KR)

Correspondence Address: Pennie & Edmonds, LLP, 3300 Hillview Avenue, Palo Alto, CA, 94304, US

(21) Appl. No.: 10/329,240

(22) Filed: Dec. 23, 2002

(30) Foreign Application Priority Data
Aug. 8, 2002 (KR) 2002-46769

(51) Int. Cl. B60L 1/00

(52) U.S. Cl. 307/9.1

(57) ABSTRACT

The invention relates to a method for releasing the fail-safe mode of a multi-function switch caused by a bad contact of a mono-directional series communication line between the multi-function switch and an in-panel controller, the method comprising the steps of: prompting the in-panel controller to turn into a fail-safe mode, record an error code, and stop the control of the multi-functions if a sleep mode signal is not inputted from the multi-function switch to the in-panel controller while the multi-function switch is in its sleep mode; and prompting the in-panel controller to determine whether the multi-function switch is in its normal status after turning into the fail-safe mode, to release the fail-safe mode if the multi-function switch is in its normal status and to control the multi-functions according to the data input from the multi-function switch.

### FIELD OF THE INVENTION

The present invention relates to a fail-safe release method of a vehicular multi-function switch, and more particularly, to a fail-safe release method of a vehicular multi-function switch that releases a fail-safe mode of a multi-function switch caused by an erroneous contact of a mono-directional serial communication line between the multi-function switch and an in-panel controller.

### BACKGROUND OF THE INVENTION

In general, a switch is attached to an external circumference of a steering column to turn on/off a taillamp and a headlamp and to operate a direction indicator or blinker when the vehicle turns left or right. In addition, such a multi-function switch is operated by pushing up or pulling down the switch. An in-panel controller controls the multi-function switch based on signals received from the switch through a mono-directional serial communication line.

However, if there is bad contact between the multi-function switch and the in-panel controller, the in-panel controller does not operate correctly and must be reset. Therefore, a fail-safe release method that addresses having to reset the in-panel controller would be highly desirable.

### SUMMARY OF THE INVENTION

The present invention provides a method for releasing a fail-safe mode of a multi-function switch caused by an erroneous contact of a mono-directional serial communication line between a multi-function switch and an in-panel controller.

In accordance with an embodiment of the present invention, a method for releasing a fail-safe mode of a vehicular multi-function switch comprises the steps of prompting the in-panel controller to turn into a fail-safe mode, record an error code, and stop the control of the multi-functions if a sleep mode signal is not inputted from the multi-function switch to the in-panel controller while the multi-function switch is in its sleep mode; and prompting the in-panel controller to determine whether the multi-function switch is in its normal status after getting into the fail-safe mode, to release the fail-safe mode if the multi-function switch is in its normal status and to control the multi-function operations according to the data input from the multi-function switch.

According to the present invention, the in-panel controller checks the data sent from the multi-function switch, when the in-panel controller turns into the fail-safe mode and stops the multi-function operations recorded as an error because a sleep signal is not inputted from the multi-function switch in the sleep mode, thereby making it possible to simply release the fail-safe mode of the multi-function switch caused by a temporary abnormal data without initialization of the in-panel controller.

According to the invention there is provided a method for releasing a fail-safe mode of a vehicular multi-function switch. It is initially determined that a sleep mode signal is not being input from a multi-function switch to an in-panel controller, while the multi-function switch is in sleep mode. The in-panel controller is then turned into a fail-safe mode. An error code is recorded and control of multi-functions of the multi-function switch is stopped It is subsequently ascertained that the multi-function switch is operating normally and the fail-safe mode is released. The ascertaining is preferably based on data transmitted from the multi-function switch to the in-panel controller. This data is repeatedly transmitted a preset number of times after transmission of a wake-up signal when the multi-function switch converts from its sleep mode to normal operation. The multi-function switch is then controlled as usual.

### BRIEF DESCRIPTION OF THE DRAWINGS

For fuller understanding of the nature and objects of the invention, reference should be made to the following detailed description taken in conjunction with the accompanying drawings in which:

FIG. 1 is a control block view for illustrating a fail-safe releasing method of a vehicular multi-function switch of the present invention;

FIG. 2 is a flowchart for a fail-safe releasing method of a vehicular multi-function switch;

FIG. 3 is a flowchart for illustrating a fail-safe releasing method of a vehicular multi-function switch of the present invention;

FIG. 4A is a signal transmitting data frame of a vehicular multi-function switch of the present invention; and

FIG. 4B is a signal transmitting data frame of a vehicular multi-function switch during the normal operational times in accordance with the present invention.

### DETAILED DESCRIPTION OF THE INVENTION

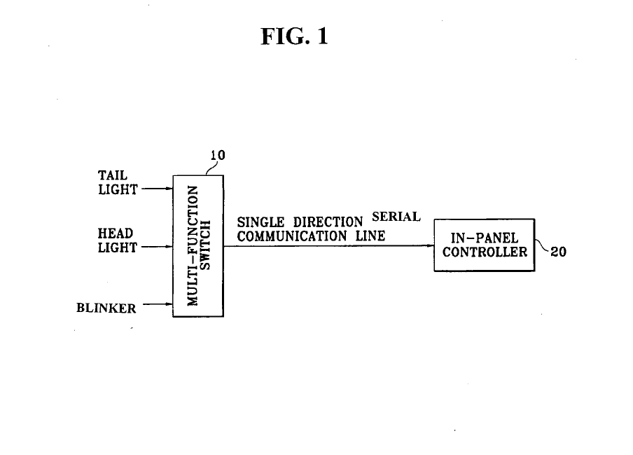

As shown in FIG. 1, a multi-function switch 10 is provided for manipulating the on/off operations of a taillamp, headlamp, a direction indicator (blinker), or the like. An in-panel controller 20 is provided for determining and controlling operations based on sleep and wake-up signals received from the multi-function switch through a mono-directional serial communication line, and for recording an error code and stopping operations when an abnormal signal is inputted.

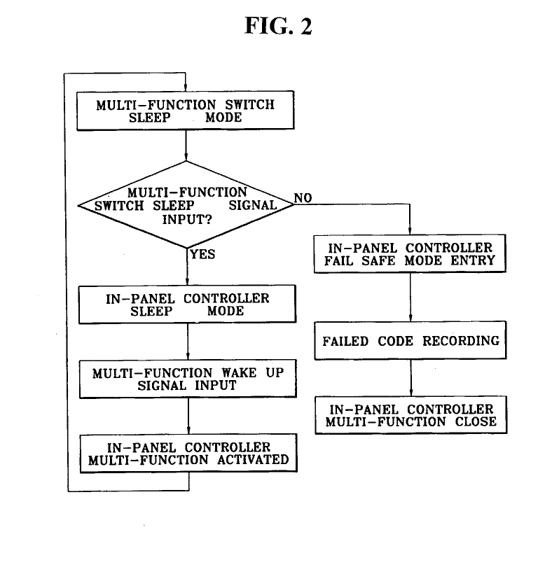

The controlling process between the multi-function switch and in-panel controller through the mono-directional serial communication line, as shown in FIG. 2, determines whether a sleep mode signal is inputted from the multi-function switch when the multi-function switch is set to a sleep mode. When the sleep mode signal is inputted, the in-panel controller operates in sleep mode. The sleep mode is defined as maintaining a stand-by status whereby the multi-function switch and in-panel controller maintain their stand-by status to minimize vehicular parasitic current between set periods of time, such as when there is no input signal from each input terminal after the ignition is shut off as when a micro-computer starts to perform an energy saving function.

The multi-function switch goes into sleep mode after reception of 4 sleep bits when one sleep bit is defined as a period of time, 3 seconds after the ignition switch and tail lamp switch have been turned off. When a wake-up signal is inputted from the multi-function switch at the sleep operational mode of the in-panel controller, the in-panel controller repeats the steps of operating the multi-functions. However, when there is no input of the sleep mode signal to the multi-function switch in its sleep mode, the in-panel controller turns the multi-function switch into its fail-safe mode, records an error code and stops operation of the multi-function switch.

The fail-safe mode is defined as a mode in which the in-panel controller determines all operating abnormaltie of units connected to it, and stops all of the units functions to prevent undesirable operational phenomenon.

The multi-function switch, which sends data to the in-panel controller through a mono-directional serial communication line, is used as a mechanism that the in-panel controller senses the operational failure of the multi-function switch. If the sleep data of the multi-function switch is not inputted through the mono-directional serial communication data line from the multi-function switch when the in-panel controller turns into its sleep mode, the in-panel controller determines the multi-function switch has an error, initiates its fail-safe mode and later records an error code.

However, if the sleep data of the multi-function switch is not properly inputted due to a bad contact of the mono-directional serial communication line, the in-panel controller does not operate all functions of the multi-function switch even if it performs the fail-safe mode to enable the multi-function switch to input normal signals. In case of the aforementioned problem, an additional step of initializing the in-panel controller is required to restore the functions of the multi-function switch.

The initialization of the in-panel controller means that, when the in-panel controller performs a fail-safe mode to the multi-function switch, the in-panel controller records an error code and maintains the fail-safe mode up to a hardware reset. Therefore, there is a problem with this method for releasing a fail-safe mode of an in-panel controller in that it is made possible only by a battery reset.

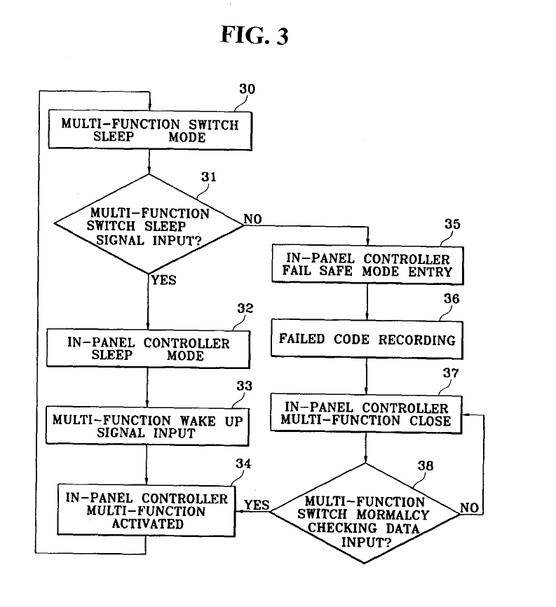

As shown in FIG. 3, the method for releasing a fail-safe mode of a vehicular multi-function switch comprises the steps of: setting the multi-function switch at an initial sleep mode (Step 30); determining whether a sleep mode signal is inputted from the multi-function switch 10 in the previous step of Step 30 (Step 31); prompting the in-panel controller 20 to start the sleep mode operations when the sleep mode signal is inputted in the previous step of Step 31 (Step 32); prompting the in-panel controller 20 to input a wake-up signal from the multi-function switch 10 when the in-panel controller 20 is in its sleep mode in the previous step of Step 32 (Step 33); prompting the in-panel controller 20 to operate the multi-function operations when the wake-up signal is inputted in the previous step of Step 33 (Step 34); prompting the in-panel controller 20 to turn into a fail-safe mode when the sleep signal is not inputted from the multi-function switch 10 at step Step 31 (Step 35); prompting the in-panel controller 20 to record an error code in the previous step of S35 (S36); prompting the in-panel controller 20 to stop or close the multi-function operations after an error code is recorded at step Step 36 (Step 37); and prompting the in-panel controller 20 to check that normal confirmation data is inputted from the multi-function switch 10 after the multi-function operations are stopped at step Step 37 (Step 38).

According to a method of the present invention thus constructed, there is a multi-function switch 10 assembled at an external circumference of a steering column for turning on/off the taillamp, or headlamp, and operating a directional indicator (blinker) when a vehicle turns left or right. There is also a mono-directional serial communication line between the multi-function switch 10 and an in-panel controller 20 that controls operations based on the signals of the multi-function switch 10.

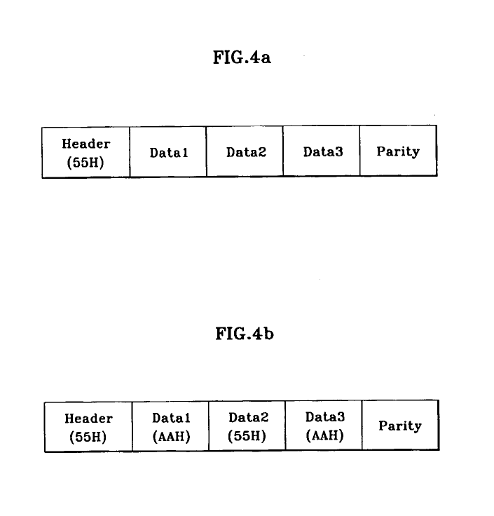

The data transmitted from the multi-function switch 10 through the mono-directional series communication line to the in-panel controller 20 consists of 5 bytes within frame 1 shown in FIG. 4a. A start of the frame is always made by a header byte having a value of 55H.

Therefore, when a sleep mode signal is inputted from the the multi-function switch 10 through the mono-directional serial communication line to the in-panel controller 20 at a step where the multi-function switch 10 is set to sleep mode (step 31), the in-panel controller 20 enters into the sleep mode by the sleep mode signal (step 32).

When the multi-function switch 10 is turned from sleep mode to a normal operation mode with the in-panel controller 20 being turned to a sleep mode, the multi-function switch preferably transmits a header byte to the in-panel controller 20 once as a wake-up signal and then transmits data to the in-panel controller 20 10 ms later (step 33). If the multi-function switch 10 is not working properly, the in-panel controller 20 transmits the data frame shown in FIG. 4b three times and confirms the transmission of data to return its fail-safe mode to its normal operational mode. In other words, the in-panel controller 20 prompts the multi-function switch 10 to return to its normal operations by applying the header byte and the data frame confirming normal operations of the multi-function switch at the time of wake-up even if the in-panel controller 20 turns into a fail-safe mode. Then, the in-panel controller 20 operates its multi-function operations when the data transmitted from the multi-function switch 10 is normal (step 34).

If the sleep signal is not inputted from the multi-function switch 10 in its sleep mode, the in-panel controller 20 determines that the normal sleep signal is not inputted due to an erroneous contact of the mono-directional serial communication line and it turns into a fail-safe mode (step 35). Then, the in-panel controller 20 proceeds to a fail-safe mode to determine the erroneous operations of the multi-function switch 10 and record an error code (step 36), and the in-panel controller 20 stops its multi-function operations (step 37).

Even if the in-panel controller 20 is in a fail-safe mode, and if the multi-function switch 10 is not erroneous, but is operating normally, the in-panel controller 20 re-operates the multi-function switch 10 by applying the header byte transmitted at the wake-up time of multi-functions as shown in FIG. 4a previously set at the multi-function switch 10, even after its multi-function is stopped. The normal confirmation data frame, as shown in FIG. 4b, is transmitted when the multi-function switch 10 is not erroneous. However, if the multi-function switch 10 is not operating normally, the in-panel controller 20 stops its multi-function operations (step 38).

As described above, there are advantages in the method for releasing the fail-safe mode of a multi-function switch, in that, when a sleep signal is not inputted from the multi-function switch, the in-panel controller turns into its fail-safe mode, records an error code and stops its multi-function operations. The in-panel controller then confirms the data transmitted from the multi-function switch to perform the multi-function operations if the multi-function switch is in its normal state, thereby prompting the in-panel controller to re-operate the multi-function switch in a simple manner without the inconvenience of initializing the in-panel controller in spite of a temporary operational breakdown of the multi-function switch.

The foregoing descriptions of specific embodiments of the present invention are presented for purposes of illustration and description. They are not intended to be exhaustive or to limit the invention to the precise forms disclosed. Obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method for releasing a fail-safe mode of a vehicular multi-function switch, the method comprising the steps of:
prompting an in-panel controller into a fail-safe mode, recording an error code, and stopping controlling of multi-functions, if a sleep mode signal is not inputted from a multi-function switch to the in-panel controller while the multi-function switch is in its sleep mode; and
prompting the in-panel controller to determine whether the multi-function switch is in its normal status after turning into the fail-safe mode, releasing the fail-safe mode if the multi-function switch is in its normal status and controlling the multi-functions according to the data input from the multi-function switch.

2. The method as defined in claim 1, wherein the multi-function switch operates in its normal status based on data transmitted from the multi-function switch to the in-panel controller.

3. The method as defined in claim 2, wherein the data for confirming the normal status of the multi-function switch is repeatedly transmitted a preset number of times after transmission of a wake-up signal when the multi-function switch converts from its sleep mode to normal operations.

4. A method for releasing a fail-safe mode of a vehicular multi-function switch, the method comprising the steps of:
determining that a sleep mode signal is not being input from a multi-function switch to an in-panel controller, while the multi-function switch is in sleep mode;
turning the in-panel controller into a fail-safe mode;
ascertaining that the multi-function switch is operating normally;
releasing the fail-safe mode; and
controlling the multi-function switch.

5. The method of claim 4, further comprising, before said ascertaining, recording an error code.

6. The method of claim 4, further comprising, before said ascertaining, stopping the control of multi-functions of said multi-function switch.

7. The method as defined in claim 4, wherein said ascrtaining is based on data transmitted from the multi-function switch to the in-panel controller.

8. The method as defined in claim 7, wherein the data for confirming the normal operation of the multi-function switch is repeatedly transmitted a preset number of times after transmission of a wake-up signal when the multi-function switch converts from its sleep mode to normal operation.
